(19) United States
(12) Patent Application Publication
(10) Pub. No.: US 2019/0267002 A1
(43) Pub. Date: Aug. 29, 2019

(54) INTELLIGENT SYSTEM FOR CREATING AND EDITING WORK INSTRUCTIONS

(71) Applicant: William Crose, Rochester Hills, MI (US)

(72) Inventor: William Crose, Rochester Hills, MI (US)

(21) Appl. No.: 16/285,918

(22) Filed: Feb. 26, 2019

Related U.S. Application Data
(60) Provisional application No. 62/634,982, filed on Feb. 26, 2018.

(51) Int. Cl. G10L 15/22; G10L 15/26; H04R 1/02; H04R 1/04; H04R 1/40; G09B 5/04; G09B 19/00

(52) U.S. Cl. CPC G10L 15/22; G10L 15/26; H04R 1/025; G10L 2015/223; H04R 1/406; G09B 5/04; G09B 19/003; H04R 1/04

(57) ABSTRACT

A mobile training device having: a) a housing configured to be worn by a user; b) one or more speakers affixed to the housing and configured to provide the user with one or more audible prompts and one or more audible work instructions; c) one or more microphones within the housing and configured to receive one or more verbal user prompts and one or more verbal work instruction signals from the user; d) one or more processors in communication with the one or more speakers and one or more microphones, and configured to convert the one or more verbal work instruction signals into one or more work instruction data entries; e) one or more storage mediums configured to store the one or more work instruction data entries; and f) one or more algorithms stored within the one or more storage mediums and accessible by the one or more processors.

### FIELD

The present teachings generally relate to a device, system, and method for capturing, modifying, and teaching standardized operating procedures. The teachings herein may be particularly useful with a mobile device able to be worn or in proximity to an individual performing the standardized operating procedure.

### BACKGROUND

Standardized operating procedures (SOPs) are a useful tool in a variety of environments, including manufacturing, medical, banking, hospitality, military, education, and so forth. SOPs provide step-by-step instructions to help individuals, such as employees, carry out routine operations. These step-by-step instructions typically capture a break down in steps needed to carry out a cycle of the routine operation, a standard time associated with each step which estimates how long an individual should take completing that step, and an overall standard time which is an estimate of how long it should take an individual to complete the entire cycle of the routine operation. These SOPs can be beneficial in providing a standard process for all individuals to follow to complete the same routine operation, reduce variability in the duration of the routine operation and the work quality resulting from the routing operation, facilitate training of new individuals, reduce injuries by identifying the best method of completing one or more steps in the cycle, and even provide a baseline to identify inefficiencies and opportunities for continuous improvement. Traditionally, SOPs are captured either via typing or handwriting. The SOPs are then printed into tangible form or displayed on a screen so an individual may refer to them while learning the standardized operating procedure, or even changing the procedure.

Developing standardized operating procedures is typically a time-consuming and tedious process. Usually, one or more industrial, process, or manufacturing engineers, or similar, observe multiple, repeat cycles of a process to document all of the steps performed by an individual and the time required to complete each step. While developing the SOP, the engineer may need to pause the process multiple times to understand and capture (e.g., typing) the work completed by the individual. This pause may result in creating downtime in a manufacturing environment, in the individual resuming the process with hesitation and not following the typical standardized process, and even inaccurate time being captured to complete the process. Furthermore, typically when changing an SOP, the industrial engineer is required to go through a similar procedure again, documenting the changes in steps, such as the order steps are completed in.

As companies continue to expand globally, they may duplicate processes abroad or want to share common processes. Although an SOP may already exist for a certain routine operation which occurs almost identically across multiple site locations, a language difference results in an SOP being unusable across facilities in which national languages may be different. Additionally, in regions where individuals (e.g., employees) may speak a number of languages, or they are not fluent in the country's primary language, the individual may not be able to understand the SOPs provided in the workplace.

Generally, when new businesses start up, they do not have the resources available to capture their processes, standard processes have not been developed, or processes may even be constantly changing as the businesses grows. Smaller businesses or start-ups may find it difficult to afford the cost of additional employees, such as industrial engineers, to capture their current processes and develop a baseline.

When individuals begin training on a process, the individual generally refers to the SOPs to learn the steps required. As the SOPs are typically either provided in paper format or electronic format (e.g., computer monitor), the individual generally only able to remember a few steps at a time. Thus, the individual repeatedly pauses the process to refer to the SOP and to determine the next steps to be completed. This may require another individual trained in the process to assist to avoid downtime, or may result in downtime, or may result in additional process time. In an effort to address some of these concerns, mobile devices which provide a means for training employees via audio without relying on visuals have been developed, such as the mobile training device disclosed in U.S. Pat. No. 9,595,201, incorporated herein by reference in its entirety for all purposes. Notwithstanding the above, there is still a need for a simple device which not only provides SOPs via audio, but also allows for changing SOPs via text recognition and audio controls.

What is needed is a training device system which allows for SOPs to be captured without requiring observing an individual to document the tasks. What is needed is a training device system which can receive audible step-by-step instructions of a process and generate both audible and documented SOPs. What is needed is a training device system which is able to automatically convert both the written and spoken language of an SOP. What is needed is a training device system which can be used to both audibly receive SOPs and receive audible input from a user to modify SOPs.

### SUMMARY

The present disclosure relates to a mobile training device and system comprising: a) a housing which is configured to be portable; b) one or more speakers configured to provide a user with one or more audible prompts and one or more audible work instructions; c) one or more microphones configured to receive one or more user prompts and one or more verbal work instruction signals from the user; d) one or more processors located within the housing configured to convert the one or more verbal work instruction signals into one or more work instruction data entries; e) one or more storage mediums within the housing configured to store the one or more work instruction data entries; and f) one or more algorithms stored within the one or more storage mediums and accessible by the one or more processors configured to: i) create and/or edit one or more of the work instruction data entries based on one or more of the user prompts and one or more of the verbal work instruction signals; and ii) chronologically sequence a plurality of the work instruction data entries and consolidate into a single work instruction record.

The present disclosure relates to a mobile training device comprising: a) a housing which is configured to be portable and worn by a user; b) one or more speakers affixed to the housing and configured to provide the user with one or more audible prompts and one or more audible work instructions; c) one or more microphones within the housing and configured to receive one or more verbal user prompts and one or more verbal work instruction signals from the user; d) one or more processors located within the housing, in communication with the one or more speakers and one or more microphones, and configured to convert the one or more verbal work instruction signals into one or more work instruction data entries; e) one or more storage mediums within the housing, in communication with the one or more processors, and configured to store the one or more work instruction data entries; and f) one or more algorithms stored within the one or more storage mediums and accessible by the one or more processors configured to: i) create, edit, or both one or more of the work instruction data entries based on one or more of the user prompts and one or more of the verbal work instruction signals; and ii) chronologically sequence a plurality of the work instruction data entries and consolidate into a single work instruction record.

The present disclosure relates to a method for creating a work instruction record comprising: a) one or more processors providing one or more audible prompts to a user via one or more speakers of a mobile training device; b) one or more users providing one or more audible user prompts, one or more verbal work instruction signals, or both into a microphone of the mobile training device; c) one or more processors receiving the one or more verbal work instruction signals and converting to one or more work instruction data entries and sending to one or more storage mediums; d) one or more or more storage mediums receiving the one or more work instruction entries and storage within one or more databases to create a work instruction record.

The disclosure provides for a method for translating a work instruction data entry comprising one or more translation algorithms instructing one or more processors to translate one or more work instruction data entries from an initial language to an intermediate language, final language, or both. The disclosure further relates to a method of training one or more users via a mobile training device with one or more of the translated work instruction records. The disclosure also relates to a method of editing work instructions initially recorded, accessible, or both by a mobile training device.

### BRIEF DESCRIPTION OF DRAWINGS

FIG. 1 illustrates a mobile training device system according the teachings herein.

FIG. 2 is a perspective view of a mobile training device from an exterior face according to the teachings herein.

FIG. 3 is a perspective view of a mobile training device from an exterior face according to the teachings herein.

FIG. 4 is a perspective view of a mobile training device from an inward face according to the teachings herein.

FIG. 5 illustrates a mobile training device according to the teachings herein, which fits over an ear of a user.

FIG. 6 illustrates a mobile training device according to the teachings herein, which locates within an ear of a user.

FIG. 7 illustrates a mobile training device according to the teachings herein, which locates within an ear of a user.

FIG. 8 illustrates a mobile training device according to the teachings herein, which locates within an ear of a user.

FIG. 9 illustrates a mobile training device according to the teachings herein, which rests atop a head and fits over an ear of a user.

FIG. 10 illustrates a mobile training device according to the teachings herein, which is able to be located in proximity to a user.

FIG. 11 illustrates an exemplary record including work instructions recorded by the mobile training device system according to the teachings herein.

FIG. 12 illustrates an exemplary database including a plurality of records and work instructions recorded by the mobile training device system according to the teachings herein.

FIG. 13 illustrates a process flow for using the mobile training device and system for creation of a work instruction record.

### DETAILED DESCRIPTION

The explanations and illustrations presented herein are intended to acquaint others skilled in the art with the present teachings, its principles, and its practical application. The specific embodiments of the present teachings as set forth are not intended as being exhaustive or limiting of the present teachings. The scope of the present teachings should be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

The present teachings relate to a mobile training device system. The mobile training device system may function to record work instructions, convert verbal work instructions to readable work instructions (e.g., voice-to-text), translate work instructions, store work instructions, play work instructions, or a combination thereof. The mobile training device system may provide for a mobile training device which is able to connect and disconnect from one or more computing devices, upload recorded work instructions to one or more memory storage devices, download recorded work instructions from one or more memory storage devices, edit recorded work instructions by verbal and/or text-based editing, develop one or more work instruction reports, or any combination thereof. The mobile training device system may include one or more mobile training devices, communication hubs, networks, servers, computing devices, or any combination thereof. A mobile training device may be removably connectable to the network, communication hub, server, computing device, or combination thereof.

Mobile Training Device

The mobile training device system may include a mobile training device (i.e., device). The mobile training device may function to provide audible work instructions to a user, receive audible work instructions from a user, convert audible work instructions to work instruction data entries, convert work instruction data entries to audible work instructions, translate work instruction data, store work instruction data, transmit work instruction data, or any combination thereof. The mobile training device may be any type of device suitable to be located in proximity to a user. In proximity may include any suitable distance in which a user may audibly hear the mobile training device, the mobile training device may recognize voice data from a user, or both. In proximity may include being worn by the user, located adjacent to a user, located within the same work station as user, or any combination thereof. The mobile training device may include one or more speakers. The mobile training device may be wired, wireless, or both. A wired connection may be temporary, removable, or permanent. A temporary or removable wired connection may be affixed via a connection port. The wired connection may be used to transmit power, data, or both to the device. The mobile training device may include a housing. The housing may be configured such that the device is portable, wearable, or both by a user. Portable may mean the device is easy to move about and have in proximity and/or on a user. An attachment mechanism may allow for the device to be wearable. The housing may include an exterior face, inward face, peripheral wall, or a combination thereof. An exterior face may face away from a user, include one or more control mechanisms, microphones, indicators, or a combination thereof. An inward face may include one or more speakers, attachment mechanisms, microphones, or both. A peripheral wall may connect the inward face to the exterior face. A peripheral wall may be affixed to or integral with one or more attachment mechanisms. An interior of the mobile training device may be defined by the inside of the housing, as the distance between the inward face and exterior face, enclosed by the peripheral wall, or any combination thereof. The mobile training device may include one or more attachment mechanisms, one or more control mechanisms, one or more speakers, one or more microphones, one or more transceivers, one or more power sources, one or more switches, one or more indicators, one or more connections, one or more processors, one or more storage mediums, one or more communication modules, or any combination thereof. An exemplary mobile training device and configurations may include those disclosed in U.S. Pat. No. 9,595,201 which is incorporated by reference herein in its entirety for all purposes.

The mobile training device may include one or more attachment mechanisms. The one or more attachment mechanisms may function to affix the training device to a user, a surface, or both. The one or more attachment mechanisms may be any mechanism suitable for affixing or placing the training device on a user, a surface, or both. The one or more attachment mechanisms may include a mechanism wearable about a user, such as a lanyard. The one or more attachment mechanisms may include a mechanism affixable to an ear of a user; such as an over-ear clip, an in-ear wing, an in-ear clip, in-ear bud size adapters, the like, or a combination thereof. The one or more attachment mechanisms may function to affix the training device over the head of a user; such as an over-ear headband. The one or more attachment devices may function to affix the training device to clothing of a user; such as one or more magnets, pins, hook and loop fasteners, clips, the like, or a combination thereof. The one or more attachment devices may function to affix the training device to a surface. The one or more attachment devices may include one or more clips, magnets, hooks, fasteners, the like, or a combination thereof. The one or more attachment mechanisms may be part of, extend from, or be attached to a housing of the mobile training device. The one or more attachment mechanisms may be affixed with or integral with the housing, speaker, or both. The one or more attachment mechanisms may extend from an exterior face, inward face, peripheral wall, or combination thereof. An exemplary housing may be the housing portion described in U.S. Pat. No. 9,595,201.

The mobile training device may include one or more power sources. The one or more power sources may function to power one or more components of the device. The one or more power sources may include any power source adapted to provide temporary, continuous, discontinuous power, or a combination thereof. The one or more power sources may be located within the housing, affixed to the housing, remote from the housing, or a combination thereof. The one or more power sources may include one or more energy storage units, current adapters, generators, transformers, rectifiers, filters, voltage regulators, the like, or a combination thereof. One or more energy storage units may include one or more batteries, capacitors, or both. One or more energy storage units may be temporarily or permanently electrically connected to one or more alternative energy sources, such as a solar panel. One or more suitable power sources may be a battery. A battery may be one such as described in U.S. Pat. No. 9,595,201. The battery may be in electrical connection with any of the one or more components of the mobile training device. The electrical connection may be direct and/or indirect. The electrical connection may be temporary, permanent, or both. The one or more power sources may be charged via a wireless and/or wired connection. The one or more power sources may be temporarily or permanently connected to one or more power providing sources, such as via one or more connectors.

The mobile training device may include one or more connector ports. The one or more connector ports may provide for transmission of electrical current, transmission of data signals, or both. The one or more connector ports may be in electrical communication with one or more power sources, processors, storage mediums, or any combination thereof. The one or more connector ports include an opening formed in a housing of a mobile training device. The opening may pass through an exterior face, inward face, peripheral wall, or any combination thereof. The one or more connector ports may comply with a rating, pursuant to International Electrotechnical Commission (IEC) 60529, of IPX1 or higher, IPX3 or higher, or even IPX5 or higher. The one or more connector ports may include a cover or may be exposed. A cover may prevent entry of contaminants (e.g., dust, water) into the port. The one or more connector ports may be any connection suitable for transmitting electrical current, data signals, or both. The one or more connector ports may include one or more USB ports (e.g., USB type A, USB type B, USB type C, USB mini A, USB mini B, USB micro A, USB micro B, and the like), Alternating Current ports, Ethernet sockets, the like, or a combination thereof.

The mobile training device may include one or more user control mechanisms. The one or more user control mechanisms may allow for a user to control one or more functions of the mobile training device. The one or more user control mechanisms may have any suitable design or configuration for controlling one or more functions of the mobile training device. One or more functions of the mobile training device may include powering the device on and off; temporarily disabling the device (e.g., sleep or hibernation mode); activating one or more transceivers of the device; connecting the device to one or more other components of the system (e.g., activating wireless connection); initiating, pausing, stopping, repeating, and/or advancing recording of and/or playing of one or more instructions (e.g., steps of one or more instructions); activating a microphone, deactivating a microphone, activating receiving and/or transmitting data, the like, or any combination thereof. One or more control mechanisms may perform a single function or a plurality of functions. One or more processors may analyze interaction of a user with a control device to analyze the function to be performed by the device. One or more processors may include one or more control algorithms stored therein, such as within one or more storage mediums. The one or more control algorithms may be configured to determine the function of a control mechanism. The one or more user control mechanisms may be in or on a housing of the training device. The one or more control mechanisms may be located on an exterior face, inward face, peripheral wall, or a combination thereof. The one or more user control mechanisms may include one or more mechanical control mechanisms, electrical control mechanisms, or both. One or more mechanical control mechanisms may include one or more buttons, switches, wheels, the like, or a combination thereof. One or more electrical control mechanisms may include one or more touch sensors, switches, accelerometers, or a combination thereof. Each switch may correspond with a button or other mechanical control mechanism. One or more switches may include one or more power switches, step switches, play switches, the like, or any combination thereof. One or more power switches may close, open, or both an electrical circuit of the device. Closing of a power switch may close an electrical circuit of the device so that the device is powered on. Powering on may mean power (e.g., current) may flow from a power source through the electrical components of the device. Opening of a power switch may open an electrical circuit of the device so that the device is powered off. Powering off may mean power (e.g. current) is unable to flow from a power source to electrical components of the device. One or more step switches, play switches, the like, or both may work with one or more processors, storage mediums, the like, or a combination thereof. Closing, opening, or both of a switch may allow for electrical signals to be received by one or more processors. The electrical signal received by a processor from one or more switches may instruct the processor to cooperate with a storage medium, software, algorithms, or a combination thereof. The electrical signal received by a processor may allow for the processor to play, record, pause, repeat, confirm, the like, one or more work instructions. One or more touch sensors may include one or more capacitive touch sensors, resistive touch sensors, infrared touch sensors, surface acoustic wave touch sensors, the like, or a combination thereof. One or more touch sensors may detect gestures with or without direct contact. One or more accelerometers may detect force exerted on the device. One or more accelerometers may detect a user tapping the device. One or more mechanical control mechanisms may be connected to one or more electrical control mechanisms. For example, one or more buttons may be connected to one or more electrical circuit switches. The one or more user control mechanisms may include one or more power buttons, volume control buttons, play buttons, pause buttons, stop buttons, record buttons, forward buttons, repeat buttons, the like, or a combination thereof. The one or more control mechanisms may be in electrical communication with one or more processors. The one or more mechanical control mechanisms, the one or more electrical control mechanisms, or both may have predetermined functions (e.g., power, play, pause, stop, volume, forward, backward, repeat, and the like) or the functions may be programmable by the user. For example, the device may be provided to the user set to repeat upon actuation of a mechanical button but the user may program the device to repeat upon double tapping the device whereby the function of the device is controlled via an accelerometer. The one or more control mechanisms may be similar to those switches disclosed in U.S. Pat. No. 9,595,201.

The mobile training device may include one or more speakers. One or more speakers may function to provide audible prompts to one or more users, audibly repeat work instructions recorded by the device for review and/or editing by a user, audibly provide recorded work instructions to a user for training and/or performing a process, or a combination thereof. One or more speakers may have any configuration suitable for providing audible prompts and instructions to a user. The one or more speakers may be intended to be worn by or in proximity to a user. One or more speakers may include a speaker which may fit within an ear of a user, be located external of an ear of a user, or both. The one or more speakers may include a headphone piece, a portable speaker, the like, or a combination thereof. A headphone piece may include one or more earbud headphones, in-ear headphones, on-ear headphones, over-the-ear headphones, closed-back over-ear headphones, open-back over-ear headphones, in-ear-canal headphones, the like, or any combination thereof. One or more speakers may be configured to have a volume which can only be heard by a user or be heard around the proximity of a user. One or more speakers may be affixed to and/or reside within a housing of the mobile training device. One or more speakers may be generally flush with or project from a surface (e.g., inward face, exterior face, peripheral wall) of the housing. One or more speakers may reside within an earpiece of a mobile training device. One or more speakers may be in electrical communication with one or more processors. An exemplary speaker may be the electrical speaker described in U.S. Pat. No. 9,595,201.

The mobile training device may include one or more microphones. One or more microphones may function to record voice from one or more users, receive verbal work instructions from one or more users, transmit verbal work instruction signals from one or more users, receive feedback from one or more users, or a combination thereof. One or more microphones may have any configuration suitable for receiving verbal work instructions from one or more users and transmitting to one or more other components of the mobile training device system. One or more microphones may be in electrical communication with one or more processors. One or more microphones may be affixed within the housing of the mobile training device, affixed to the housing (e.g., wired connection), separate from the housing (e.g., wireless connection), or a combination thereof. One or more microphones may include or be adjacent to an opening. The opening may allow for sound waves from the voice of a user to be received by the microphone. The opening may be formed in the housing. The opening may be formed in an exterior face, inward face, peripheral wall, or a combination thereof. The one or more microphones may transmit one or more verbal work instructional signals to the one or more processors. An exemplary microphone may be the microphone described in U.S. Pat. No. 9,595,201.

The mobile training device may include one or more indicators. The one or more indicators may function to provide a visual status of the device to one or more users. The one or more indicators may be in electrical communication with one or more processors. The one or more indicators may include one or more lights. The one or more indicators may alert the user of a status of power, power source, connection with a system or communication hub, recording, playing, the like, or any combination thereof. The one or more indicators may alert the user of any status of the device related to one or more control mechanisms. The one or more indicators may alert the user of a status of the device with color, icons, patterns (i.e., patterns of the light in an on/off state defined by duration of the light in an on/off state, frequency of light switching between an on and off state, or both), brightness, the like, or any combination thereof. For example, a green light may indicate the device is powered on. As another example, a blue light may indicate the device is connected to a system. As another example, a pattern consisting of a high frequency of light switching between an on and off state indicates the device is charging. The one or more indicators may be located on or part of the housing. The one or more indicators may be located on the exterior face, inward face, peripheral wall, or any combination thereof.

Mobile Training Device System

The mobile training device system may include one or more user movement sensors. The one or more user movement sensors may function to capture one or more physical movements of a user while the training device is recording one or more work instructions. One or more user movement sensors may be any sensor capable of sensing changes in motion of a user while recording one or more work instructions. The one or more movement sensors may include one or more accelerometers, global positioning system (GPS) receivers, gyroscope sensors, the like, or a combination thereof. The one or more sensors may also include any sensing device that can be remote from the user while detecting movement of the user. One or more remote sensing devices may include infrared cameras, video camera, software in conjunction with a camera for analyzing movement, the like, or a combination thereof. The one or more movement sensors may be in electrical communication with one or more processors, transceivers, or both. The one or more movement sensors may be in indirect communication with one or more processors, such as through one or more transceivers. The one or more movement sensors may in direct electrical communication with one or more processors. The one or more movement sensors may be integral with a mobile training device or separate from and connected to. The one or more movement sensors may be located internally or externally of a housing of a mobile training device. The one or more movement sensors may detect different motions of a user, such as lifting an arm, rotating an appendage, position of head, steps taken, distance traveled, the like, or any combination thereof. The one or more movement sensors may detect posture of a user. Upon detecting a motion, one or more motion signals may be generated. One or more motion signals may be delivered to one or more processors. One or more processors may convert one or more motion signals to one or more motion data entries. One or more motion data entries may be stored within one or more storage mediums, as part of one or more work instruction records, or both. One or more motion data entries may be correlated to or made part of a work instruction data entry. For example, while recording a work instruction step of walking to a next job station, a motion sensor may detect the movement of 10 paces and the 10 paces may then become part of the work instruction data entry. For further example, while recording a work instruction step of grabbing a fastener from a material storage rack, a motion sensor may detect an upward movement of about 15 inches of the user's arm. One or more motion algorithms may instruct one or more processors to analyze the one or more motion data entries to determine the type of motion. One or more motion data entries may be correlated to one or more predetermined postures. One or more motion data entries may be compared to one or more predetermined postures to improve the layout of a work environment of a user, identify ergonomic concerns, or both. One or more motion data entries upon correlation to one or more predetermined postures may alert a user about a difference in positions, identify an ergonomic concern, offer an improved posture, or a combination thereof in real-time.

The mobile training device system may include one or more transceivers. The one or more transceivers may function to receive one or more signals, transmit one or more signals, or both. One or more transceivers may include one or more transceivers suitable for receiving one or more signals related to one or more instructions, transmitting one or more signals related to one or more user instructions, or both. The one or more transceivers may be located within the mobile training device, another component of the mobile training device system, or both. One or more transceivers may include a single or a plurality of transceivers. One or more transceivers may be located within the mobile training device, such as within the housing. One or more transceivers may be in communication with the speaker, microphone, one or more processors, one or more communication hubs, one or more networks, or a combination thereof. One or more transceivers may be part of one or more other computing devices connected or part of the mobile training device system. The one or more transceivers may include one or more radio frequency transmitters, wireless modules, Bluetooth transmitters, near-field communication transmitters, the like, or any combination thereof. The one or more transceivers may include one or more antennas. An exemplary transceiver may be the transceiver described in U.S. Pat. No. 9,595,201.

The mobile training device system may include a communication hub. A communication hub may function to receive one or more signals, transfer one or more signals, or both from and/or to one or more mobile training devices, computing devices, servers, processors, storage mediums, the like, or any combination thereof. The communication hub may be any type of communication hub capable of sending and transmitting data signals over a network to a plurality of components of the system. A communication hub may include a wired router, a wireless router, or both. The communication hub may be connected to one or more mobile training devices, one or more computing devices, one or more servers, the like, or any combination thereof a via wired connection, wireless connection, or a combination of both. The communication hub may allow for communication of a computing device, server, or both with a mobile training device, and vice-versa, when the mobile training device is directly connected to the communication hub, indirectly connected to the communication hub, or both. A direct connection to the communication hub may mean that a device is directly connected to the communication hub via a wired and/or wireless connection, and communicates with other devices of the system or network through the communication hub. An indirect connection to the communication hub may mean that a device first communicates with one or more other computing devices part of the system via a network before transmitting and/or receiving one or more signals to and/or from the communication hub.

The system may include one or more networks. The one or more networks may be formed by placing the mobile training device in communication with one or more other computing devices. The network may include a communication hub as part of the network. One or more networks may be connected to one or more other networks. One or more networks may include one or more local area networks (LAN), wide area networks (WAN), intranet, Internet, the like, or any combination thereof. The network may be temporarily, semi-permanently, or permanently connected to one or more computing devices. One or more computing devices may include one or more mobile training devices, servers, processors, storage mediums, personal computers (e.g., laptop, desktop, etc.), mobile computing devices (e.g., tablet, mobile phone, etc.). The network may allow for one or more mobile training devices to be temporarily and/or permanently connected to transmit one or more work instruction input signals to one or more processors, storage mediums, or both. The network may comprise a topology such as a bus topology, a star topology, a ring topology, a mesh topology, a tree topology, a point-to-point topology, a hybrid topology, the like, or any combination thereof. The network may allow for one or more computing devices to receive data entries and/or signals from and/or transmit data entries and/or signals to one or more storage mediums. The network may allow for accessing one or more data entries stored within a storage medium. The one or more networks may function to allow transmission of one or more signals for processing.

The system may include one or more processors. The one or more processors may function to analyze one or more signals related to data from one or more databases, storage mediums, microphones, transceivers, mobile training devices, or any combination thereof. The one or more processors be part of, separate from, or both relative to one or more components of the mobile training device system. One or more processors may be located within a mobile training device, outside of a mobile training device, within a computing device of the mobile training device system, part of a server of a mobile training device system, within one or more communication hubs, or any combination thereof. One or more processors may be in communication with one or more other processors. The one or more processors may function to process data, convert data signals to data entries, execute one or more algorithms to analyze data, apply one or more rules, evaluate data against one or more rules, or any combination thereof. Processing data may include receiving, transforming, outputting, executing, the like, or any combination thereof. One or more processors may be part of one or more hardware, software, systems, or any combination thereof. One or more hardware processors may include one or more central processing units, multi-core processors, front-end processors, microcontrollers, the like, or any combination thereof. The one or more processors may include one or more cloud-based processors. A cloud-based processor may be part of or in communication with one or more transceivers, servers, networks, storage mediums, computing devices, or a combination thereof. A cloud-based processor may be located remote from one or more mobile training devices, a computing device, one or more other processors, one or more databases, or any combination thereof. Cloud-based may mean that the one or more processors may reside in a non-transient storage medium located remote from one or more mobile training device, computing device, processor, databases, or any combination thereof. One or more cloud-based processors may be accessible via one or more networks. One or more software processors may include one or more word processors, documents processors, the like, or any combination thereof. One or more system processors may include one or more information processors, the like, or a combination thereof. The one or more processors may be located within a same or different non-transient storage device as one or more storage mediums, other processors, transceivers, communication hubs, or any combination thereof. The one or more processors may convert data signals to data entries to be saved within one or more storage mediums. The one or more processors may access one or more algorithms to analyze one or more data entries and/or data signals.

The system may include one or more storage mediums. The one or more storage mediums may function to receive and/or transmit one or more data entries from one or more components of the system, store one or more algorithms, store computer-readable instructions (e.g., software programs), or any combination thereof. The one or more storage mediums may include one or more storage devices, memory storage devices, or both. The one or more storage devices may include one or more non-transient storage devices. A non-transient storage device may include one or more physical servers, virtual servers, physical computing devices, or a combination thereof. One or more servers may include one or more local servers, remote servers, or both. One or more storage mediums may include one or more hard drives (e.g., hard drive memory), chips (e.g., Random Access Memory “RAM”), discs, flash drives, memory cards, the like, or any combination thereof. The one or more storage mediums may be located within one or more mobile training devices, servers, computing devices, communication hubs, the like, or a combination thereof. The one or more storage mediums may be in communication with one or more processors. The one or more storage mediums may receive data entries from one or more processors, may transmit one or more data entries to one or more processors, or both. The one or more storage devices may store data in the form of one or more databases.

The system may include one or more databases. One or more databases may function to receive, store, and allow for retrieval of information related to one or more work instruction data entries. The one or more databases may be located within (e.g., stored) one or more storage mediums. The one or more databases may include any type of database able to store digital information. The digital information may be stored within one or more databases in any suitable form using any suitable database management system (DBMS). Exemplary storage forms include relational databases (e.g., SQL database, row-oriented, column-oriented), non-relational databases (e.g., NoSQL database), correlation databases, ordered/unordered flat files, structured files, the like, or any combination thereof. The one or more databases may store one or more classifications of data models. The one or more classifications may include column (e.g., wide column), document, key-value (e.g., key-value cache, key-value store), object, graph, multi-model, or any combination thereof. An exemplary row-oriented database may include a comma-separated values (CSV) file. One or more databases may be located within or be part of hardware, software, or both. One or more databases may be stored on a same or different hardware and/or software as one or more other databases. The databases may be located within one or more non-transient storage mediums. One or more databases may be located in a same or different non-transient storage device as one or more other databases. The one or more databases may be accessible by one or more processors to retrieve data entries for analysis via one or more algorithms, store one or more data entries, or both. The one or more databases may be one or more cloud-based databases. Cloud-based may mean that the one or more databases may reside in a non-transient storage medium located remote from one or more computing devices, mobile training devices, servers, or a combination thereof. One or more cloud-based databases may be accessible via one or more networks. One or more databases may include one or more databases capable of storing one or more data entries related to one or more work instructions, translated work instructions, user privileges, the like, or a combination thereof. Data entries within one or more databases may include record identification data, work instruction data, or both. Record identification data may include a record name, creator, creation date, creation time, modification date, modification time, or a combination thereof. A record name may be an identifying name of the process to be recorded. A record name may be the name of a workstation, task, procedure, the like, or a combination thereof. A creator or creator name may be the name of the user creating and recording the work instructions. A creator may be the name, user ID, nickname, the like, or a combination thereof. A creator may an individual designated as a creator, editor, and/or administrator. A creation date may be the date (e.g., month, date, year, etc.) a user creates the record, initiates creation of a record, or both. A modification date may be a date a user edits a record, initiates editing of a record, or both. A creation time may be the time a user begins creation of a record, creates a single step of work instructions, or both. The same, different, or both creation time may be assigned to step in the work instructions. Work instruction data may include a step sequence, instruction data or description, duration, feedback, and the like. A step sequence may identify what sequence (chronological order) an instruction of the record is recorded relative to others in the same record. A step sequence may be designated during recording, may be derived from a creation and/or modification time and/or date of a step, or any combination thereof. Instruction data or description may be the verbal recording, text, or both of a description of the work instruction. Duration may be a time it takes for one instruction or step to be recorded, completed, or both. Duration may be measured from the time voice starts to end, from the time the user initiates recording a step (such as by a control mechanism or voice) to the time a user ends a step, or both. Feedback may be recorded, verbal or text, information provided by a user. The feedback may be provided when finishing recording a work record, editing a work record, or both. One or more data entries sharing a similar or same record identification data may be part of a single record.

The one or more databases may include one or more user privilege databases. The one or more user privilege databases may allow for users to have certain privileges with respect to the work instructions of a device, system, or both. The user privilege databases may identify who may create, edit, play, delete, administrate, or a combination thereof one or more records, work instructions, fields, entries, the like, or any combination thereof. A user privilege database may identify users via one or more data entries. The one or more data entries may include a user name or login, password and/or passphrase, access rights, or a combination thereof. A user name may be the same, different, or be correlated to a creator or creator name. A user name may identify a user. A password and/or passphrase may be a verbal, text, or both word or phrase to allow a user to interact with a device and/or system at their designated privilege rights. Access rights may identify what level of access privileges a user may have relative to the system, device, or both. Access rights may include administrator, creator, deletion, editor, operator, the like, or any combination thereof. Administrator may allow a user full privileges, from creating and modifying other user rights to the full creating and editing privileges of work instructions and/or records. A creator may be allowed to record, edit, delete, and play work instructions and/or records. An editor may be allowed to edit and play work instructions. A deletor may be allowed to delete work instructions. An operator may be allowed to play the work instructions. A user, to begin a method of creating and/or editing work instructions with a device, may have to verbally provide their user name and password and/or passphrase to the device via a microphone.

The mobile training device system may include one or more algorithms. The one or more algorithms may function to analyze one or more verbal instructions, one or more work instruction entries, modify one or more work instruction entries, or a combination thereof. One or more algorithms may be located in the same or multiple components of the mobile training device system. One or more algorithms may be located within one or more storage mediums, processors, or both of one or more servers, computing devices, mobile training devices, or any combination thereof. One or more algorithms may be accessible by one or more processors. One or more algorithms may instruct one or more processors to retrieve one or more data entries, analyze one or more signals, the like, or any combination thereof.

One or more algorithms may include one or more speech-to-data (e.g., voice-to-text) algorithms. The one or more speech-to-data algorithms may function to convert one or more verbal work instruction data signals to one or more work instruction data entries. One or more verbal work instruction data signals may be received by one or more microphones as one or more sound waves. The one or more speech-to-data algorithms may have any configuration to transform the one or more sound waves to text and as associated data entries for saving in one or more storage mediums. The one or more speech-to-data algorithms may cause one or more processors to convert one or more sound waves to a digitized sound. A digitized sound may include removing unwanted noise, separating the sound waves into different bands of frequency, normalizing a sound, adjusting a volume level of the sound, adjusting the speed of the sound waves to a predetermined speed identified in the algorithm, or any combination thereof. The one or more speech-to-data algorithms may instruct one or more processors to divide out one or more digitized sounds into smaller segments of sound. The one-or-more speech-to-data algorithms may instruct one or more processors to match segments of digitized sound to one or more phonemes of the indicated native language. One or more native languages may be stored within one or more storage mediums for use with one or more algorithms. One or more speech-to-data algorithms may instruct one or more processors to compare one or more phenomes to one or more other phenomes in close timing (e.g., occurrence) proximity. One or more speech-to-data algorithms may cause one or more processors to apply one or more speech rules. The one or more speech rules may include one or more grammatical rules, syntactical rules, or both relative to speech. More information about grammatical rules, syntactical rules, or both may be found https://electronics.howstuffworks.com/gadgets/high-tech-gadgets/speech-recognition2.htm, incorporated herein in its entirety for all purposes. The one or more speech rules may include one or more statistical modeling systems, such as the Hidden Markov Model and/or Neural Networks. Upon application of one or more speech rules, the one or more processors may calculate one or more data entries in text form. By application of one or more speech rules, one or more verbal work instruction signals are converted to one or more work instruction data entries. The one or more work instruction data entries are able to be stored within one or more storage mediums or one or more databases, accessible by one or more mobile training devices for audible repetition, accessible by one or more computing devices for viewing, editing, and even printing a text-based version of one or more work instruction data entries, or any combination thereof.

One or more algorithms may include one or more instruction algorithms. The one or more instruction algorithms may function to convert one or more verbal work instruction data signals into one or more work instruction data entries, provide one or more work instruction records, and/or one or more work instruction reports; chronically sequence one or more work instruction data entries; or any combination thereof. The one or more instruction algorithms may be stored within or separate from the mobile training device. The one or more instruction algorithms may be accessible by one or more processors. The one or more instruction algorithms may instruct one or more processors to provide one or more verbal prompts. One or more verbal prompts may be stored within the algorithm, stored within a storage medium, or both. One or more verbal prompts may be a verbal prompt provided audibly via the speaker of the mobile training device. The one or more instruction algorithms may instruct one or more processors how to analyze one or more input data signals received by a device from a user. One or more input data signals may include one or more verbal data signals (e.g., voice) or one or more physical data signals (e.g., touch). One or more instruction algorithms may instruct one or more processors to start, pause, and/or stop recording one or more verbal work instruction data signals; start, pause, and/or stop a timer during completion of work associated with one or more verbal work instruction data signals; how to store one or more work instruction data entries within one or more databases; or any combination thereof. One or more instruction algorithms may include one or more rules based on one or more user prompt words, user prompt actions, or both. One or more instruction algorithms may instruct one or more processors to apply one or more rules based on one or more user prompt words and/or actions received by the device. One or more user prompt words and/or actions may include prompts which instruct the device to start, pause, and/or stop recording a work instruction record; delete one or more work instruction steps; re-record one or more work instruction steps; proceed to recording a subsequent work instruction step; finalize recording of a work instruction record; or any combination thereof. Based on the user prompt, one or more processors may create a work instruction record, locate a work instruction data entry into a specific location within a database (e.g., a row), separate one or more work instruction data entries into separate locations (e.g., separate rows), chronologically sequence one or more work instruction data entries, finalize a record, or any combination thereof. Upon finalizing of one or more work instruction records, one or more report algorithms may generate one or more work instruction reports.

One or more algorithms may include one or more report algorithms. One or more report algorithms provide for displaying one or more work instruction records for observation, editing, or both. One or more report algorithms may be stored in any computing device capable of providing or transmitting a work instruction record in a viewable format. One or more report algorithms may include one or more template formats for collecting and displaying one or more work instruction records from one or more databases. One or more template formats may include one or more fields related to one or more records. For example, one template format may include a plurality of fields related to each data entry related to a single record. The one or more fields may display data entries relates to record identification data, work instruction data, or a combination thereof. One or more report algorithms may instruct one or more processors to access one or more work instruction record entries, display one or more work instruction record entries, or both. One or more report algorithms may sort for any data entries sharing the same or similar record identification data. One or more report algorithms may chronologically sequence one or more work instructions by step sequence. One or more work instruction reports may instruct one or more processors to display one or more work instruction data entries which have one more record information data entries in common. Record information data entries may be the data entries in a database related to record information. For example, one or more work data entries sharing the same record name, creator, and/or the like may be displayed together. Upon display via a user interface, a user may choose to edit one or more work instruction data entries. One or more report algorithms may allow for a user to edit one or more data entries and instruct one or more processors to replace one or more previous data entries with the edited entry. One or more report algorithms may instruct one or more processors to print one or more work instruction entries, such as to a printer in communication with a processor via a network.

One or more algorithms may include one or more translation algorithms. One or more translation algorithms may function to translate one or more work instruction records from an initial language to a final language. One or more translation algorithms may instruct one or more processors to translate one or more work instruction data entries from an initial language to an intermediate language, final language, or both. An intermediate language may be a language to which a first language (e.g., native language) is first converted to before converting to a final language. For example, one or more data entries received in Spanish may first be converted to English before being translated to Japanese. An intermediate language may reduce the complexity in the translation algorithm my exponentially reducing the translation data needed in the system. The one or more translation algorithms may include one or more rules. One or more rules may include statistical machine translation, neural machine translation, word alignment, language modeling, or a combination thereof. Statistical machine translation may be syntax-based, phrase-based, or both. The one or more rules may be similar to those found at https://en.wikipedia.org/wiki/Google_Translate and https://en.wikipedia.org/wiki/Microsoft_Translator, incorporated herein by reference in their entirety for all purposes. Upon translation of one or more work instruction data entries and/or records, the one or more translation algorithms may instruct one or more processors to replace the previous work instruction data entry and/or record in the initial language or create a duplicate work instruction data entry and/or record in the final language to create a translated work instruction data entry and/or record. The translated data entries may be stored in one or more duplicate databases in the intermediate language, final language, or both. The only difference between the original database and duplicate database is the language of the work instructions. The one or more translation algorithms may instruct one or more processors to store a translated work instruction record within one or more storage mediums for subsequent retrieval.

One or more algorithms may include one or more motion detection algorithms. The one or more motion detection algorithms may function to analyze one or more motion signals to determine one or more types of motion made by a user while wearing a mobile training device. One or more motion algorithms may function to instruct one or more processors to analyze one or more motion data entries, such as to determine the type of motion. One or more algorithms may instruct one or more processors to correlate or pair one or more motion data entries to one or more work instruction data entries. The one or more motion algorithms may include one or more motion rules. The one or more motion rules may provide rules which determine, based on the motion data entry, the type of motion sensed based on the motion data, record the type of motion in the work instruction database, correlate the type of motion to one or more work instruction steps in a work instruction database and/or within a record, or any combination thereof. The one or more motion rules may include determining reaching, distance, walking, turning, twisting with an arm, bending, squatting, gripping, using tools, the like, and so forth. The one or more motion algorithms may instruct one or more processors to apply one or more motion rules to match one or more motion rules to one or more motion data entries.

The mobile training device system include one or more user interfaces. The one or more user interfaces may function to receive input from one or more users. The one or more user interfaces may be part of, separate, or both relative to a mobile training device, system, or both. The one or more user interfaces may include one or more microphones, speakers, control mechanisms, the like, or any combination thereof. The one or more user interfaces may include one or more visual interfaces, one or more input devices, or both.

The mobile training device system may include one or more visual interfaces. The visual interface may function to provide visual instructions to a user, cooperate with the mobile training device to provide both simultaneous audible and visual instructions to a user, allow a user to see what is being received verbally received by the mobile training device, allow a user to edit the work instructions, or a combination thereof. The one or more visual interfaces may allow for inputting of information related to a user, user account, one or more work instruction data entries, work instruction records, or any combination thereof. The one or more visual interfaces may allow for retrieval, displaying, and/or transmission to one or more processors, storage mediums, computing devices, mobile training devices, input devices, the like, or any combination thereof. The one or more visual interfaces may be connected to one or more components of the system be a direct or indirect connection. The one or more visual interfaces may be connected to one or more components of the system via the network. The one or more visual interfaces may include a tablet, a monitor screen (e.g., affixed to one or more processors), a television, an augmented reality device, or any combination thereof. The one or more visual interfaces may be in communication with one or more input devices.

The mobile training device system may include one or more input devices. The one or more input devices may allow for receiving of one or more inputs from a user. The one or more inputs devices may include one or more keyboards, computer mice, cameras, microphones, touch-sensitive monitors, control mechanisms, sensors, any other input device, the like, or any combination thereof. The one or more input devices may allow for creation, editing, and/or deletion of one or more work instruction data entries, work instruction records, or both. The one or more input devices may allow for user inputs to be received by one or more processors, storage mediums, computing devices, mobile training devices, visual interfaces, the like, or any combination thereof. The one or more input devices may be connected to one or more components of the system be a direct or indirect connection. The one or more input devices may be connected to one or more components of the system via the network.

Method of Using Mobile Training Device and System

The present disclosure provides for a method of creating a work instruction record using the mobile training device system disclosed herein.

The method may include one or more processors providing one or more audible prompts to a user. The one or more audible prompts may be relayed to a user via one or more speakers. One or more algorithms may instruct one or more processors to provide the one or more audible prompts.

The method may include one or more users providing one or more audible user prompts, one or more verbal instruction signals, or both. The one or more audible prompts or signals may be received via a microphone. The microphone may be part of or connected to a mobile training device. The one or more audible prompts may be received as one or more sound waves. The method may include converting one or more sound waves to one or more digitized sounds. The method may include application of one or more speech-to-data algorithms to convert the one or more sound waves to one or more digitized sounds. The method may include application of one or more translation algorithms comprising one or more speech rules by one or more processors to convert one or more segments of digitized sound to text. The text may include one or more words, phrases, sentences, numbers, the like, or any combination thereof. The text may be saved as one or more work instruction data entries.

The method may include one or more verbal work instruction signals being converted to one or more work instruction data entries. One or more algorithms may instruct one or more processors to convert the verbal work instruction signals to one or more work instruction data entries. One or more instruction algorithms may instruct one or more processors to convert the one or more verbal work instruction signals to one or more work instruction data entries. The one or more work instruction data entries may be transmitted to one or more storage mediums, one or more databases, other processors, or any combination thereof. The one or more work instruction data entries may be sent to a storage medium from a process based on one or more instruction algorithms. The one or more work instruction algorithms may instruct a user when one work instruction data entry begins, ends, and/or is paused. The one or more work instruction algorithms may receive one or more audible and/or physical user prompts to identify the beginning and/or end of a work instruction data entry. The one or more work instruction algorithms may instruct one or more processors to respond to one or more prompt words (e.g., trigger words such as “Pythia”, “next”, “begin recording”, “yes”, “no”, “delete”, etc). The one or more work instruction algorithms may instruct one or more processors to time duration of one or more work instructions. A start time, end time, or both may be initiated by one or more audible and/or physical user prompts.

The method may include one or more storage mediums receiving one or more work instruction data entries. The method may include one or more processors transmitting one or more work instruction data entries based on instruction from one or more algorithms. One or more algorithms may include one or more instruction algorithms. The method may include one or more instruction algorithms instructing one or more processors to direct one or more work instruction data entries to one or more storage mediums. The one or more work instruction data entries may be stored within one or more databases. The one or more work instruction data entries may be stored as a CSV file. The one or more work instruction work instruction data entries may be stored within a database as part of a work instruction record. The one or more instruction algorithms may instruct one or more processors to sequence one or more work instruction data entries, such as chronologically. The one or more work instruction data entries may be sequenced in chronological order to provide for a work instruction record.

The method may include editing and/or deleting one or more work instruction data entries. The method may include the mobile training device receiving one or more verbal and/or physical user prompts to edit and/or delete one or more work instruction data entries. The one or more work instruction data entries may be edited and/or deleted from a storage medium. The one or more work instruction data entries may be edited and/or deleted from a storage medium in a similar manner as one or more work instruction data entries are created.

The method may include generating one or more work instruction reports. The method may include one or more report algorithms instructing one or more processors to retrieve one or more work instruction data entries from one or more storage mediums, display one or more work instruction data entries via a visual interface, tangible medium (e.g., paper by printing), or both. The one or more report algorithms may instruct one or more processors to display a plurality of work instruction data entries which comprise a single work instruction record in a pre-formatted report template.

The method may include a user manually editing one or more work instruction reports. The method may include a user retrieving and editing one or more work instruction data entries from one or more storage mediums. The user may access the work instructions via a device, user interface, or both. The user may edit the work instructions verbally. Verbal editing may be completed via a microphone of the device. The user may edit the work instructions in written form. The user may access a work record and/or work instruction via a user interface with a display and input. The user may edit one or more entries of a record and/or work instruction via the input.

The present disclosure may provide for a method of translating a work instruction record using the mobile training device system disclosed herein. The method may include one or more translation algorithms instructing one or more processors to translate one or more work instruction data entries from an initial language to an intermediate language, final language, or both. The method may include first translating the one or more work instruction data entries from the initial language to the intermediate language, followed by translating the one or more work instruction data entries from the intermediate language to the final language. The one or more translation algorithms may instruct the one or more processors to retrieve one or more of the work instruction data entries from one or more of the storage mediums. The method may include the one or more translation algorithms instructing the one or more processors to apply one or more language rules. For example, the one or more language rules may include statistical machine translation, neural machine translation, work alignment, language modeling, or a combination thereof. The method may include one or more translation algorithms instructing one or more processors to store one or more work instruction data entries into one or more storage mediums after translation to result in one or more translated work instruction data entries. The method may include one or more translation algorithms instructing the one or more processors to replace previous work instruction data entries, create new work instruction data entries, or both with the translated work instruction data entries. The method may include one or more report algorithms instructing the one or more processors to generated one or more reports with the translated one or more work instruction data entries to provide a translated work instruction record.

The present disclosures may provide for a method of training a user with one or more audible work instructions using the mobile training device system disclosed herein. U.S. Pat. No. 9,595,201 provides an exemplary approach for using the mobile training device for work instruction training.

### ILLUSTRATIVE EMBODIMENTS

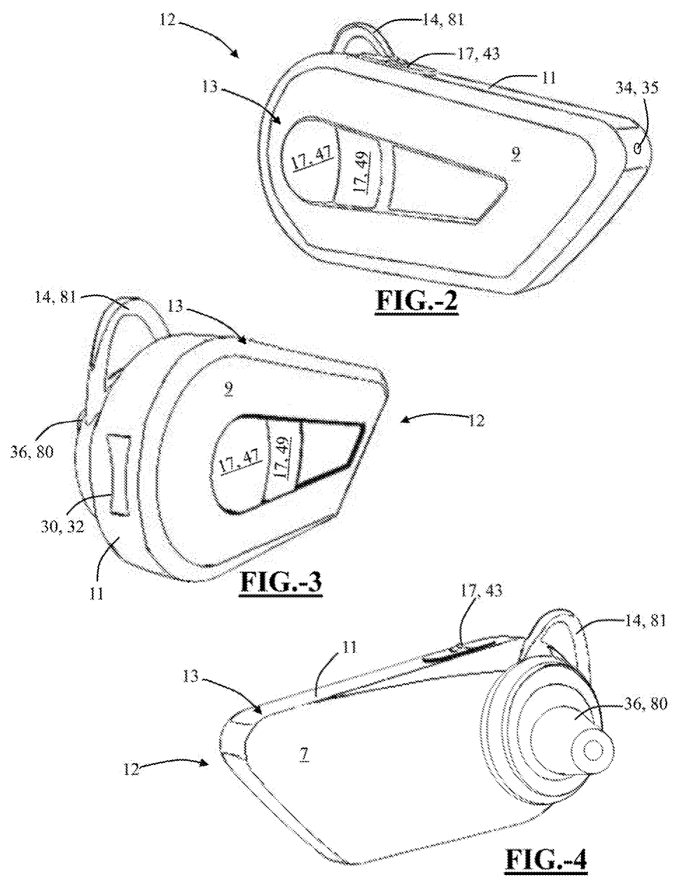

The following descriptions of the Figures are provided to illustrate the teachings herein, but are not intended to limit the scope thereof. Features of any one embodiment may be employed in another. For example, any of the attachment mechanisms and speakers of FIGS. 2-8 may be used with or in lieu of one another.

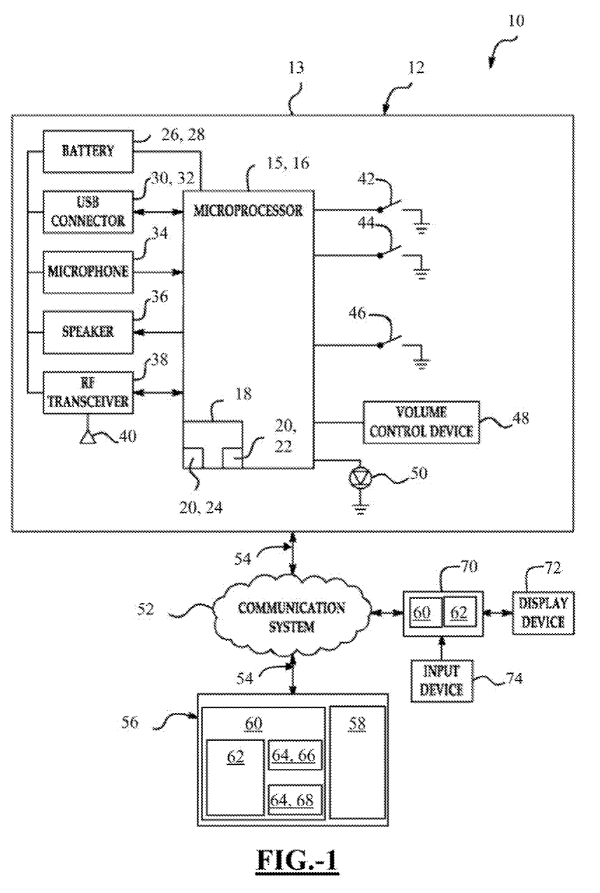

FIG. 1 illustrates a mobile training device system 10. The system 10 includes a mobile device 12 having a housing 13. The mobile device 12 includes a processor 15, which is a microcontroller 16. The microcontroller 16 includes at least one storage medium 18 and software programs 20 (e.g., including algorithms). The storage medium includes a voice recognition software program 22 and a training software program 24. The microcontroller 16 is electrically coupled to a power source 26 in the form of a battery 28, at least one connection port 30 in the form of a USB port 32; a microphone 34; a speaker 36; and at least one transceiver 38 which may include an antenna 40. The microcontroller 16 is electrically coupled to a power switch 42, a step switch 44, a play switch 46, and a volume control device 48. The microcontroller 16 is also electrically coupled to an indicator 50. The mobile device 12 is in communication with a communication hub 52. The communication hub 52 integrates the mobile device 12 into a network 54. In communication with the network 54 is a server 56. The server 56 includes a server processor 58 and at least one storage medium 60. Stored within the at least one storage medium 60 are one or more instruction databases 62 and one or more algorithms 64. The one or more algorithms 64 include a voice-to-text algorithm 66 and a translation algorithm 68. Also connected to the connection hub 52 is a computing device 70. The computing device 70 includes a storage medium 60 and a processor 62. The computing device 70 also includes a visual user interface 72 and a user input interface 74.

FIGS. 2-4 illustrate a mobile training device 12. The mobile training device 12 includes a housing 13. The device 12 includes an attachment mechanism 14. The attachment mechanism 14 is in the form of an in-ear clip 81. The in-ear clip 81 is configured to tuck into a concha of a user's outer ear (not shown). The attachment mechanism 14 is in proximity to a speaker 36. The speaker 36 is in the form of an in-ear bud 80. The device 12 includes a connection portion 30. The connection port 30 may be a USB port 32 as shown. The device 12 includes a plurality of control mechanisms 17. The control mechanisms 17 include a power button 43. The power button 43 is located on a peripheral wall 11 of the housing 13. The peripheral wall 11 connects an exterior face 9 of the device 12 to an inward face 7. The control mechanisms 17 also include a volume button 49. The volume button 49 is located on the exterior face 9 of the housing 13. The control mechanisms 17 further include a play button 47. The play button 47 is also located on the exterior face 9 of the housing 13. The device 12 also includes a microphone 34. The microphone 34 includes an opening 35 formed in the peripheral wall 11 of the housing 13.

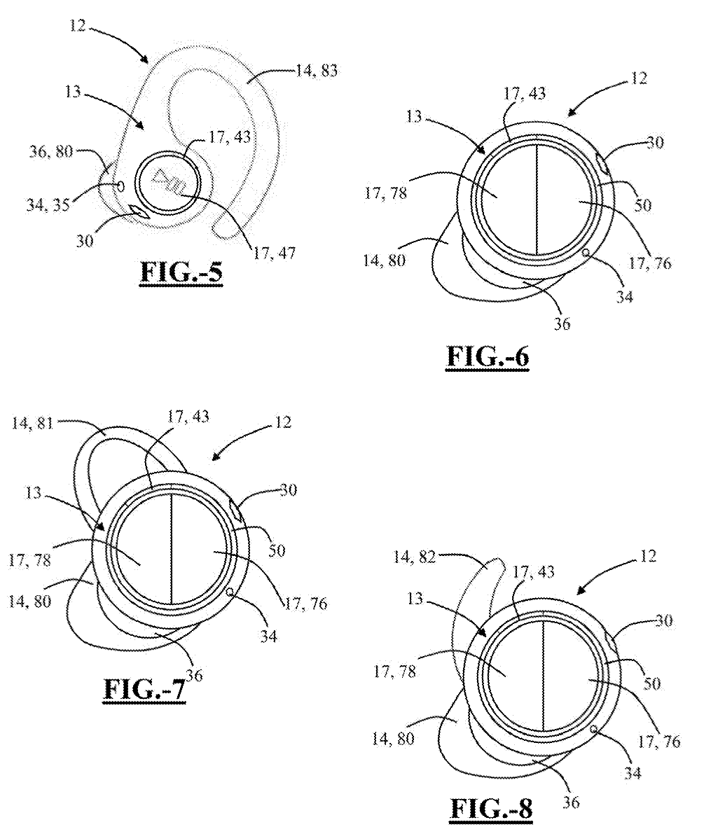

FIG. 5 illustrates a mobile training device 12. The mobile training device 12 includes a housing 13. Extending from the housing 12 is an attachment mechanism 14. The attachment mechanism 14 is in the form of an over-ear clip 83. The device 12 includes a connection port 30. The connection port 30 is formed in the housing 13. The device 12 includes a plurality of control mechanisms 17. The control mechanisms 17 include a power button 43 and a play button 47. The control mechanisms 17 are located opposite a speaker 36. The speaker 36 is in the form of an earbud 80. The device 12 also includes a microphone 34. The microphone 34 includes an opening 35 formed in the housing 13.

FIG. 6 illustrates a mobile training device 12. The mobile training device 12 includes a housing 13. The device includes a connection port 30. The device 12 includes a plurality of control mechanisms 17. The control mechanisms 17 include a power button 43, a start/stop button 76, and navigation button 78. The device 12 includes an indicator 50. The device 12 includes a microphone 34. The device 12 includes an attachment mechanism 14 projecting from the housing 13 and located adjacent to the speaker 36. The attachment mechanism 14 is an in-ear bud 80.

FIG. 7 illustrates a mobile training device 12. The mobile training device 12 includes a housing 13. The device 12 includes a connection port 30. The device 12 also includes a power button 43, a start/stop button 76, and navigation button 78. The device 12 includes an indicator 50. The device 12 includes a microphone 34. The device 12 includes an attachment mechanism 14. The attachment mechanism 14 is an in-ear bud 80 and in-ear clip 81. The in-ear bud 80 is located adjacent to a speaker 36.

FIG. 8 illustrates a mobile training device 12. The mobile training device 12 includes a housing 13. The device 12 includes a connection port 30. The device 12 also includes a power button 43, a start/stop button 76, and navigation button 78. The device 12 includes an indicator 50. The device 12 includes a microphone 34. The device 12 includes an attachment mechanism 14. The attachment mechanism 14 is an in-ear bud 80 and an in-ear wing 82. The in-ear bud 80 is located adjacent to a speaker 36.

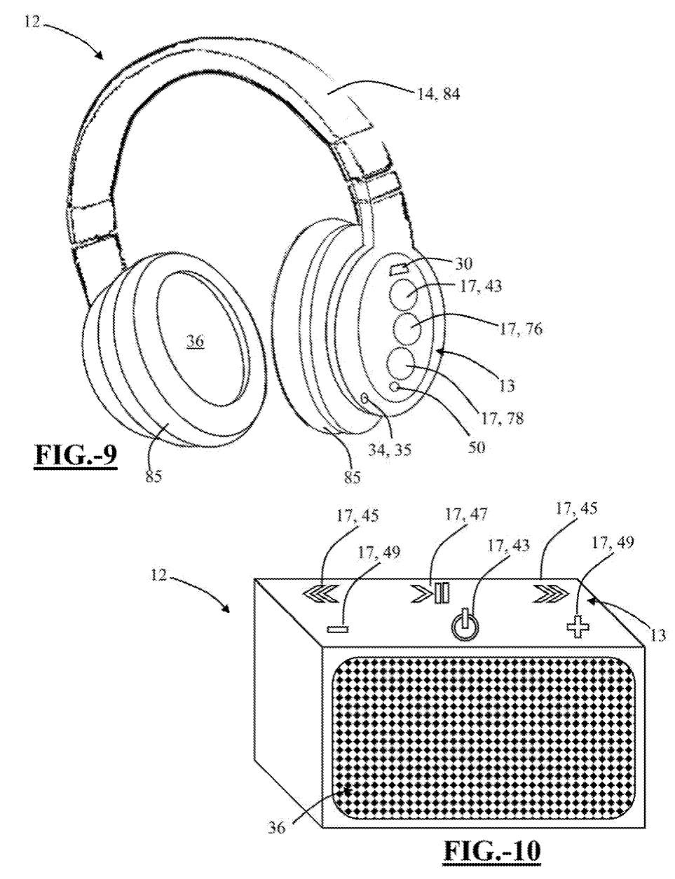

FIG. 9 illustrates a mobile training device 12. The mobile training device 12 includes a housing 13. The device includes a connection port 30. The connection port 30 is formed in the housing 13. The device 12 also includes a plurality of control mechanisms 17. The control mechanisms 17 include a power button 43, a start/stop button 76, and navigation button 78. The device 12 includes an indicator 50. The device 12 includes a microphone 34. The device 12 includes an attachment mechanism 14 projecting from the housing 13. The attachment mechanism 14 is a headband. The housing 13 includes a plurality of speakers 36. Formed about the speakers 36 are cushioned earcups 85.

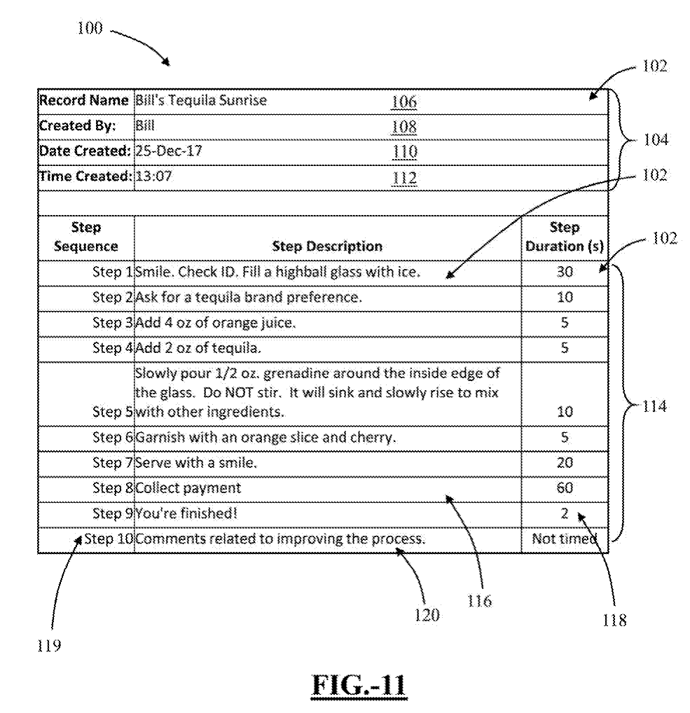

FIG. 10 illustrates a mobile training device 12. The mobile training device includes a housing 13. Included within the housing 13 is a speaker 36. The device 12 includes a power button 43, volume buttons 48, step button 45, and play button 47. The device 12 is configured to rest on a surface (not shown).

FIG. 11 illustrates a record 100. FIG. 11 may display how a record 100 is shown on a visual user interface 72 (not shown), such as that part of or connected to a computing device 70 (not shown). The record 100 includes a plurality of fields 102. The fields 102 include record identification data 104. The record identification data 104 includes a record name 106, creator 108, creation date 110, and creation time 112. The fields 102 include work instruction data 114. Work instruction data 114 includes individual steps 116 and a duration 118 of each step 116. The work instruction data 114 is sorted sequentially by step sequence 119 in the order the individual steps 116 should be completed. Work instruction data 114 further includes feedback data 120.

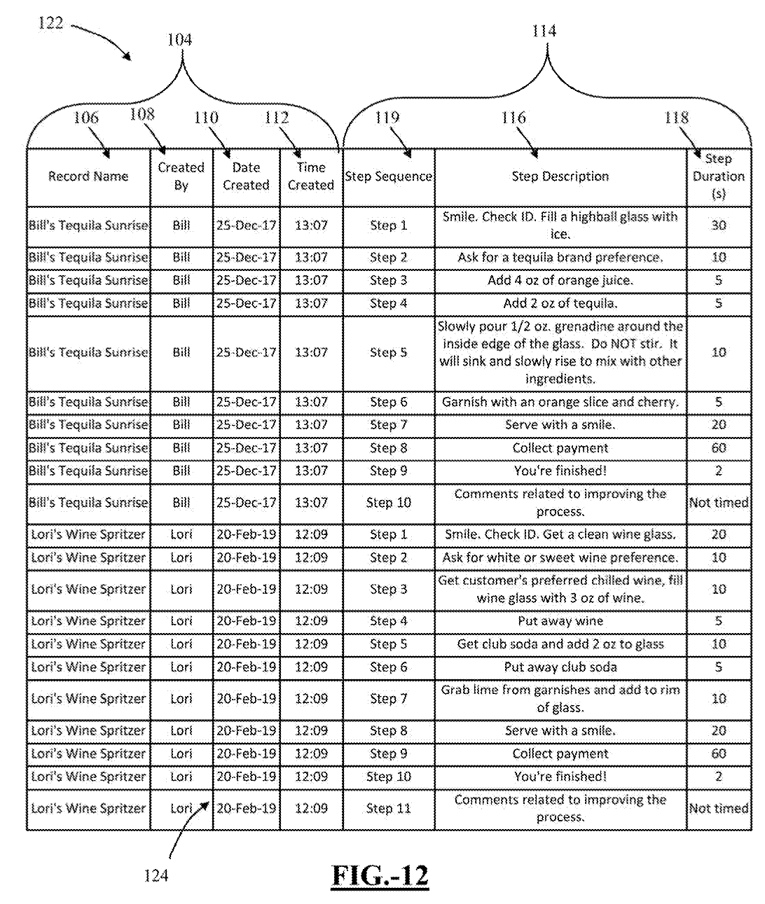

FIG. 12 illustrates a record database 122. The record database 122 includes all of the data displayed in one or more records 100. The record database 122 includes a plurality of data entries 124. The data within the data entries 124 may be the data then displayed in fields 102 of a record 100. Each data entry 124 includes record identification data 104. The record identification data 104 includes record name 106, creator 108, creation date 110, and creation time 112. The record identification data 104 identifies which data entry 124 is associated with a single record 100. For example, each data entry 124 with a record name 106 “Bill's Tequila Sunrise” is part of the record 100 as shown in FIG. 11. Each data entry 124 further includes work instruction data 114. The work instruction data 114 includes a step sequence 119, description of the individual step 116, and a duration 118 of the individual step 119. If the data entries 124 are record in one language but need to be saved in a second language, there may be a plurality of record databases 122. One record database 122 may be in the recorded language while a second, record database 122 may be in the common language. For example, the plurality of data entries 124 may be recorded in Spanish as saved in a record database 122. Via a translation algorithm 68 (not shown), the plurality of data entries 124 may be saved to a similar record database 122 but in a common language, such as English.

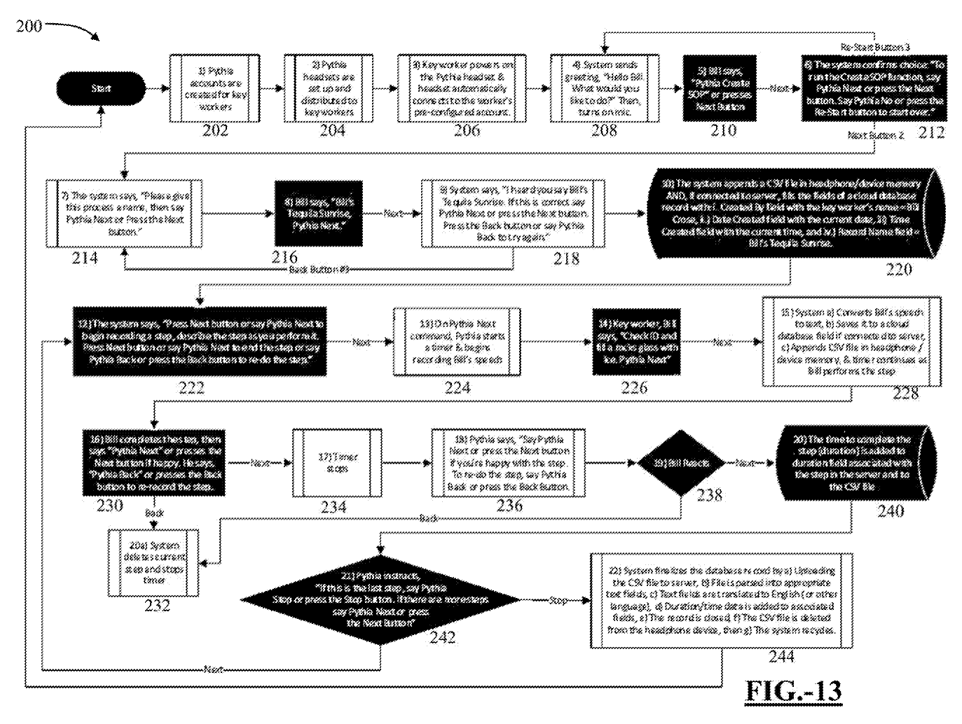

FIG. 13 illustrates a process 200 for recording work instruction data 114 and creating a record 100 with a mobile training device system 10. To begin the process 200, user accounts are created 202 for users of the mobile training device system 10. Mobile training devices 12 are then distributed to the users 204. To begin using a device 12, a user powers on 206 the device 12. Upon powering on, the device 12 automatically connects to an account for the user. As an alternative, the device may ask the user for log-in credentials which are verbally received from a user. Upon receiving the log-in credentials, the device 12 may connect to the account of the user. After connecting, the device 12 will provide an audible greeting 208 via the speaker 36. The user will then provide instructions to create a work instruction record 210. The device 12 will ask for confirmation 212 that the user wants to proceed with creation of a work instruction record 210. The user may verbally or physical (e.g., push button) to proceed or go back to the greeting 208 or menu of the device 12. If the user confirms to proceed with creation of a work instruction record, the device 12 will ask the user to provide record identification data 104, specifically by requesting for a record name 106 in step 214. The user will verbally respond with a record name 106 in step 216. Upon receiving a record name via a microphone, the microphone may transmit the user verbal input signal to a processor within the device which may convert the verbal user input signal to user input data entry stored within a storage medium within the device. This may occur for all user verbal input signals during creation of a work instruction record 210. After receiving the record name 106, in step 218 the device will audibly confirm the record name and request for verbal of physical confirmation from the user. If the record name is correct, the processor proceeds to step 220 in which the processor may further include a creator name associated with the user, a creation date, and a creation time and store these also with the record name 106 to create a record identification data entry within the storage medium. Upon creation of the record identification data entry, the device 12 audibly informs the user to proceed with recording a process 222 to create a work instruction record 210. To begin recording, the user can either provide a verbal instruction or physical instruction to the device 12. Upon receiving instruction from the user to begin recording work instructions, the device 12 records the verbal recording of the user 224 until the user provides verbal instruction to proceed to recording to the next step 226. During recording, the user verbally says what work he or she is completing or observing. After the user provides verbal instruction to proceed to the next step 228, the verbal work instruction signal associated with a work instruction step is transmitted to the processor which converts the verbal work instruction signal into a work instruction data entry and also pairs the recorded time duration of the step with the work instruction data entry. Also after providing the verbal instruction to proceed to the next step 228, the device begins recording the verbal work instruction signal and time duration of the next step 230. After completion of recording a step and before proceeding, the user has the option of deleting a work instruction data entry 232 and re-recording that verbal work instruction while completing the work instruction step. If the user is satisfied with the work instruction data entry 232 recorded into the device 12, a time recording is also stopped 234. The user can then react 238 to proceed with recording subsequent steps or go deleted a work instruction data entry and repeat recording. After completing a single or multiple work instruction step recordings, a user can provide a verbal or physical instruction to the device 12 that the process is complete 242. Upon receiving the verbal or physical instruction, the device 12 will audibly request feedback from the user regarding the process. Any feedback received from the user via the microphone is received as a verbal feedback data signal. The verbal feedback data signal is converted by the processor into a verbal feedback data entry and stored with the record 100. After receiving feedback, the record is then finalized 244.

### EXAMPLES

The following are examples of how the interfaces of different exemplary mobile training device 12 may be utilized.

The power button 43 of the device 12 of any of FIGS. 2-10 may be held for a duration of time, such as 1 second to 5 seconds to power the device on and off. The power button 43, such as shown in FIGS. 5-7 may also provide a volume adjustment with a single, short (e.g., staccato) press for turning the volume down and two short presses for turning the volume up. A single volume button 49, as shown in FIGS. 2-4, may also adjust volume. Pressing the button once may turn the volume up. Pressing the button twice consecutively may turn the volume down. Volume may be adjusted in increments of about 2% or greater, about 5% or greater, or even about 10% or greater. Volume may be adjusted in increments of about 20% or less, about 15% or less, or even about 12% or less. Even separate volume buttons 49, as shown in FIG. 10 may adjust volume.

The play button 47 of FIGS. 2-10 may allow for initiating playing and/or recording of a work instruction record. For example, a work instruction may be played or recorded by a single short press, proceeding to a next step of a work instruction by a single short press (if a work instruction has already commenced), and/or may provide for an affirmative response (e.g., “yes”) from a user by a single short press (e.g., such as when answering a question from the device 12). The play button 47 may pause a work instruction by pressing the button for a long period of time, such as 0.5 seconds to 2 seconds. The play button 47 may allow for going back a step or menu, repeating a work instruction step, or providing a negative response (e.g., “no) by being pressed with two short presses.

The start/stop button 76 of the device 12 of FIGS. 6-9 may provide for beginning pausing, and/or ending playing and/or recording of a work instruction record. A short, staccato press before a work instruction record begins may result in starting a record. A short, staccato press after a work instruction record begins may result in pausing recording and/or playing of a record. A short, staccato press during one of the device's prompts or while no record is active may result in moving to a next step or prompt. A longer duration press (e.g., 0.5 seconds to 2 seconds) may result in end recording and/or playing of a work instruction record and signal the completion of the work instruction.

The navigation button 78 of the device 12 of FIGS. 6-9 may provide for navigating one or more verbal menus of the device (e.g., verbal prompts). A short press of the navigation button 78 may result in re-starting from a menu or going back to a prompt. A double press of the navigation button 78 may provide for deletion of a recorded work instruction step (e.g., work instruction step data entry).

The indicator 50 of the device 12 of FIGS. 1-9 may be in the form of an LED light. The LED light may be the color red when disconnected from a network, not yet connected to a user account, or both. The LED light may be the color red when connected to a network, connected to a user account, or both. The LED may flash red when indicating low power of a power source within the device.

Any numerical values recited in the above application include all values from the lower value to the upper value in increments of one unit provided that there is a separation of at least 2 units between any lower value and any higher value. These are only examples of what is specifically intended and all possible combinations of numerical values between the lowest value, and the highest value enumerated are to be considered to be expressly stated in this application in a similar manner. Unless otherwise stated, all ranges include both endpoints and all numbers between the endpoints.

Any numerical values recited in the above application include all values from the lower value to the upper value in increments of one unit provided that there is a separation of at least 2 units between any lower value and any higher value. These are only examples of what is specifically intended and all possible combinations of numerical values between the lowest value, and the highest value enumerated are to be considered to be expressly stated in this application in a similar manner. Unless otherwise stated, all ranges include both endpoints and all numbers between the endpoints.

The term “consisting essentially of” to describe a combination shall include the elements, ingredients, components, or steps identified, and such other elements ingredients, components or steps that do not materially affect the basic and novel characteristics of the combination. The use of the terms “comprising” or “including” to describe combinations of elements, ingredients, components, or steps herein also contemplates embodiments that consist essentially of the elements, ingredients, components, or steps.

Plural elements, ingredients, components, or steps can be provided by a single integrated element, ingredient, component, or step. Alternatively, a single integrated element, ingredient, component, or step might be divided into separate plural elements, ingredients, components, or steps. The disclosure of “a” or “one” to describe an element, ingredient, component, or step is not intended to foreclose additional elements, ingredients, components, or steps.

1. A mobile training device for digitally recording, editing, and playing one or more work instructions comprising:
a) a housing which is configured to be portable and worn by a user;
b) one or more speakers affixed to the housing and configured to provide the user with one or more audible prompts, one or more audible work instructions, or both;
c) one or more microphones within the housing and configured to receive one or more verbal user prompts, one or more verbal work instruction signals from the user;
d) one or more processors located within the housing, in communication with the one or more speakers and one or more microphones, and configured to convert the one or more verbal work instruction signals into one or more work instruction data entries;
e) one or more storage mediums within the housing, in communication with the one or more processors, and configured to store the one or more work instruction data entries; and
f) one or more algorithms stored within the one or more storage mediums and accessible by the one or more processors configured to:
i) create, edit, or both one or more of the work instruction data entries based on one or more of the user prompts and one or more of the verbal work instruction signals; and
ii) chronologically sequence a plurality of the work instruction data entries and consolidate into a single work instruction record.

2. The mobile training device of claim 1, wherein one of the one or more algorithms includes one or more speech-to-data algorithms are configured to instruct the one or more processors to convert the one or more verbal work instruction signals from one or more sound waves to a digitized sound.

3. The mobile training device of claim 2, wherein one or more speech rules are stored within the one or more storage mediums and are accessible by the one or more processors upon instruction of the one or more speech-to-data algorithms; and
wherein the one or more speech rules include one or more grammatical rules, syntactical rules, statistical modeling systems, or a combination thereof.

4. The mobile training device of claim 1, wherein the one or more algorithms include one or more instruction algorithms configured to instruct the one or more processors to sequence the plurality of work instruction data entries in chronological order to create the single work instruction record, edit one or more individual work instruction entries based on one or more of the verbal user prompts, or both.

5. The mobile training device of claim 4, wherein the one or more instruction algorithms are configured to instruct the one or more processors to provide one or more of the audible prompts via the one or more speakers; and
wherein the one or more instruction algorithms are configured to instruct the one or more processors to create and/or edit the one or more work instruction data entries based on one or more of the verbal user prompts and/or the verbal work instruction data signals received form the user in response to one or more of the audible prompts.

6. The mobile training device of claim 1, wherein the one or more work instruction algorithms include one or more report algorithms configured to format one or more of the work instruction records for visual display.

7. The mobile training device of claim 6, wherein the one or more report algorithms are configured to instruct the one or more processors to retrieve from the one or more storage mediums and display one or more of the work instruction records to a visual user interface connected to the mobile training device, generate a printed version of the work instruction record, or both.

8. The mobile training device of claim 2, wherein the one more algorithms include one or more translation algorithms configured to translate the one or more work instruction data entries from an initial language to a final language,
wherein the one or more translation algorithms are configured to be executed after one or more speech-to-data algorithms are executed.

9. The mobile training device of claim 8, wherein the one or more storage mediums include a native language stored therein; and
wherein the one or more translation algorithms are configured to instruct the one or more processors to convert the initial language to the native language; and/or
wherein the one or more translation algorithms are configured to instruct the one or more processors to convert the native language to the final language.

10. The mobile training device of claim 9, wherein the one or more language rules are configured to instruct the one or more processors to replace, duplicate, or both the one or more work instruction data entries in an initial language, native language, or both stored in the one or more storage mediums with one or more translated work instruction data entries in the final language.

11. The mobile training device of claim 1, wherein the mobile training device is removably connectable to a mobile training device system having one or more computing devices, servers, or both via a communication hub; and
wherein the mobile training device includes one or more transceivers to be removable connected to a network via the communication hub so that the mobile training device is able to communicate over the network with the one or more computing devices, the servers, or both.

12. A method for creating a work instruction record with a computer-implemented method of a mobile training device comprising:
a) one or more processors providing one or more audible prompts to a user via one or more speakers of a mobile training device, wherein the one or more processors and the one or more speakers are affixed to a housing of the mobile training device and the housing is configured to be portable and worn by the user;
b) one or more users providing one or more audible user prompts, one or more verbal work instruction signals, or both into a microphone of the mobile training device, wherein the microphone is located within the housing;
c) the one or more processors receiving the one or more verbal work instruction signals and converting to one or more work instruction data entries and sending the one or more work instruction data entries to one or more storage mediums, wherein the one or more storage mediums are located within the housing and in communication with the one or more processors;
d) one or more or more storage mediums receiving the one or more work instruction entries and storage within one or more databases to create a work instruction record.

13. The method of claim 12, wherein the method comprises generating one or more work instruction reports by displaying the work instruction record via printing on a tangible medium, displaying electronically on a user interface, or both.

14. The method of claim 13, wherein the generating one or more work instruction reports are created by one or more report algorithms instructing one or more processors to display one or more work instruction data entries which have one or more record information data entries in common.

15. The method of claim 14, wherein the one or more report algorithms instruct the one or more processors to display a plurality of the work instruction data entries which comprise the work instruction record in a pre-formatted report template.

16. The method of claim 12, wherein one or more instruction algorithms instruct the one or more processors to provide the one or more audible prompts.

17. The method of claim 15, wherein the one or more verbal work instruction signals are received as one or more sound waves;
wherein one or more speech-to-data algorithms instruct the one or more processors to convert the one or more sound waves to digitized sounds; and
wherein the one or more speech-to-data algorithms include the application of one or more speech rules by one or more processors to convert one or more segments of the digitized sounds to text.

18. The method of claim 17, wherein at least some of the text is converted to the one or more work instruction data entries.

19. The method of any of claim 12, wherein the one or more processors time a duration of work associated with one or more work instruction data signals and include the duration as part of the one or more work instruction data entries.

20. The method of claim 12, wherein the method includes first translating the one or more work instruction data entries from the initial language to the intermediate language, followed by translating the one or more work instruction data entries from the intermediate language to the final language.
